(19) United States
(12) Patent Application Publication
(10) Pub. No.: US 2026/0246659 A1
(43) Pub. Date: Aug. 20, 2026

(54) VIDEO CONFERENCING UPON A PROXIMITY CONDITION

(71) Applicant: Truist Bank, Charlotte, NC (US)

(72) Inventors: Ryan Thomas Loesch, Cumming, GA (US); Muthukumar Gopalakrishnan, Suwanee, GA (US)

(73) Assignee: Truist Bank, Charlotte, NC (US)

(21) Appl. No.: 19/057,422

(22) Filed: Feb. 19, 2025

(51) Int. Cl. H04L 12/18

(52) U.S. Cl. CPC H04L 12/1813

(57) ABSTRACT

A video conference system includes: a computing system including at least one processor and at least one of a memory device and a non-transitory storage device, wherein said at least processor executes computer-readable instructions; a network connection for operatively connecting devices to the computing system; a first proximity sensing terminal sending an embedded-data signal to the computing system upon sensing a registration device, the signal conveying identifying data; a primary agent device in wireless communication with the computing system via the network connection; a first video conference system in communication with the computing system via the network connection; and a second video conference system in communication with the first video conference system via the network connection.

### TECHNICAL FIELD

The present disclosure relates to device activations or signaling upon a device to device proximity. More particularly, the present disclosure relates to video conferencing upon a proximity condition.

### BACKGROUND

Consumers prefer personalized experiences and are likely to continue the use of products and services when appreciation and recognition are provided. Many interactions between customers and providers of services and products occur online, where conducting transactions are typically time-efficient in relation to visits to branch offices and point-of-sale (POS) location of provider. Such visits are nonetheless in some instances needed or preferred. However, agents of providers are not always familiar at a glance with all customers and the products and services those customers use and/or require.

Traveling to a branch office and/or point-of-sale (POS) location by a customer may or may not be preceded by tell-tale activity, such as the making of an appointment, by a customer. Even when a visit is expected, arrival times and agent availability can vary. While information about user needs may be available upon searching or inquiry by an inquisitive agent, such information is not organized in relation to equipment and human resources at a branch office and/or a point-of-sale (POS) location where and when a user has arrived.

Improvements are needed in correlating user arrival with customized reception and service practices.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a video conference system includes: a computing system including at least one processor and at least one of a memory device and a non-transitory storage device, wherein said at least processor executes computer-readable instructions; a network connection for operatively connecting devices to the computing system; a first proximity sensing terminal sending an embedded-data signal to the computing system upon sensing a registration device, the signal conveying identifying data; a primary agent device in wireless communication with the computing system via the network connection; a first video conference system in communication with the computing system via the network connection; and a second video conference system in communication with the first video conference system via the network connection.

Upon execution of the computer-readable instructions, the computing system performs steps including receiving the embedded-data signal, identifying a stored user entity-profile associated with the identifying data, the stored user entity profile containing user entity specific data, and concatenating data exchanges by at least: sending first data including a portion of the user-specific data to the primary agent device, wherein the primary agent device displays content at least representative of the portion of the user-specific data; sending second data including an indication of optional content to the primary agent device, wherein the primary agent device displays content at least representative of the optional content; sending at least a first portion of the optional content to the first video conference system, wherein the first video conference system displays the first portion of the optional content. The steps performed further include: sending at least a second portion of the optional content to the second video conference system, wherein the second video conference system displays the second portion of the optional content; and conducting a video conference between the first video conference system and the second video conference system via the network connection.

Sending the first portion of the optional content to the first video conference system may include sending at least the first portion of the optional content via the network connection.

Sending the first portion of the optional content to the first video conference system may automatically trigger the first video conference system to display at least video content of the first portion of the optional content.

Before sending the first portion of the optional content to the first video conference system, the computing system may receive a prompt, via the network connection from the primary agent device, to send at least the first portion of the optional content to the first video conference system.

Receiving the prompt, via the network connection from the primary agent device, may automatically trigger the computing system to send at least the first portion of the optional content to the first video conference system.

Receiving the prompt, via the network connection from the primary agent device, may automatically trigger the computing system to select the first video conference system from multiple video conference systems in a common facility.

Receiving the prompt, via the network connection from the primary agent device, may automatically trigger the computing system to send an indication of the location of the first video conference system within the common facility to at least one of the primary agent device and the registration device.

The proximity sensing terminal and the primary agent device may be within the common facility.

The second video conference system may be remote from the common facility.

Receiving the prompt, via the network connection from the primary agent device, may automatically trigger the computing system to select the second video conference system from multiple video conference systems remote from the common facility.

Receiving the prompt, via the network connection from the primary agent device, may automatically trigger the computing system to schedule a time for the first video conference system to display the first portion of the optional content, and send an indication of the scheduled time to at least one of the primary agent device and the registration device.

The video conference system may further include a second proximity sensing terminal sending an arrival signal to the computing system upon sensing the registration device arriving at the first video conference system.

The computing system may automatically trigger the first video conference system to display at least the first portion of the optional content upon receiving the arrival signal.

The steps performed by the computing system may further include sending an offer of the optional content to the registration device.

The steps may include, upon receiving a reply to the offer from the registration device, sending at least a segment of the optional content to the registration device over the network connection.

In at least one embodiment, the first proximity sensing terminal includes at least one of a radio-frequency identification (RFID) reader and a near-field communication (NFC) device; and the primary agent device includes a mobile device including a processor, a memory device, a non-transitory storage device, a display, and an antenna.

In at least one embodiment, the registration device includes at least one: a mobile device including a processor, a memory device, a non-transitory storage device, and an antenna; and a card or fob including an embedded integrated circuit chip and an antenna.

Conducting the video conference between the first video conference system and the second video conference system via the network connection may include sending live audio and video content from the first video conference system to the second video conference system, and sending live audio and video content from the second video conference system to the first video conference system.

In some embodiments, upon execution of the computer-readable instructions, the computing system performs steps including, for each specific user entity of multiple user entities: receiving input event signals and storing corresponding timestamped input event records in a user entity-profile associated with the specific user entity, each of the timestamped input event records representing a respective quantized input event; incrementing, for at least some of the timestamped input event records, one or more quantized resource of the specific user entity by a respective input quantity; receiving output event signals and storing corresponding timestamped output event records in a user entity-profile associated with the specific user entity, each of the timestamped output event records representing a respective quantized output event; and decrementing, for at least some of the timestamped output event records, a respective output quantity from the one or more quantized resource of the specific user entity.

In at least one embodiment to which the above options and features apply as well, a method for a computing system to conducting a video conference system across a network connection, the computing system including at least one processor and at least one of a memory device and a non-transitory storage device, the network connection operatively connecting devices to the computing system, wherein, upon execution of the computer-readable instructions, the computing system performs steps including: receiving an embedded-data signal from a first proximity sensing terminal, the signal conveying identifying data; identifying a stored user entity-profile associated with the identifying data, the stored user entity profile containing user entity specific data; and concatenating data exchanges by at least: sending first data including a portion of the user-specific data to a primary agent device, wherein the primary agent device displays content at least representative of the portion of the user-specific data; and sending second data including an indication of optional content to the primary agent device, wherein the primary agent device displays content at least representative of the optional content. The steps further include sending at least a first portion of the optional content to a first video conference system, wherein the first video conference system displays the first portion of the optional content; sending at least a second portion of the optional content to a second video conference system, wherein the second video conference system displays the second portion of the optional content; and conducting a video conference between the first video conference system and the second video conference system via the network connection.

In at least one embodiment to which the above options and features apply as well, a video conference system includes: a computing system including at least one processor and at least one of a memory device and a non-transitory storage device, wherein said at least processor executes computer-readable instructions; a network connection for operatively connecting devices to the computing system; a proximity sensing terminal sending an embedded-data signal to the computing system upon sensing a registration device, the signal conveying identifying data; a primary agent device in wireless communication with the computing system via the network connection; and a first video conference system in communication with the computing system via the network connection. Upon execution of the computer-readable instructions, the computing system performs steps including receiving the embedded-data signal, identifying a stored user entity-profile associated with the identifying data, the stored user entity profile containing user entity specific data, and concatenating data exchanges by at least: sending first data including a portion of the user-specific data to the primary agent device, wherein the primary agent device displays content at least representative of the portion of the user-specific data; and sending second data including an indication of optional content to the primary agent device, wherein the primary agent device displays content at least representative of the optional content. The steps further include: sending at least a first portion of the optional content to the first video conference system, wherein the first video conference system displays the first portion of the optional content; and sending at least a second portion of the optional content to at least one of the registration device and a computing device indicated in the stored user entity-profile associated with the identifying data.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 illustrates an enterprise system and environment thereof, in accordance with various embodiments of the present invention.

FIG. 2 represents the system of FIG. 1 in abbreviated illustration to implement transacting user entity resources in at least one mode.

FIG. 3 represents the system of FIG. 1 in abbreviated illustration to implement transacting user entity resources in at least another mode.

FIG. 4 represents the system of FIG. 1 in abbreviated illustration implementing systems, devices, and methods for video conferencing upon a proximity condition.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to illustrations and/or block diagrams of systems and apparatuses (the term “apparatus” includes systems and computer program products), will be understood such that each function described or implied with reference to the illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts described, illustrated, and/or implied.

These computer program instructions may also be stored in a computer-readable memory that can direct a computer or other programmable data processing apparatus to function in a particular manner, such that the instructions stored in the computer readable memory produce an article of manufacture including instructions, which implement the function/act described, illustrated, and/or implied.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts described, illustrated, and/or implied. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein. Where functions of hardware and software are described herein, related methods are detailed therewith, such that methods are disclosed as well.

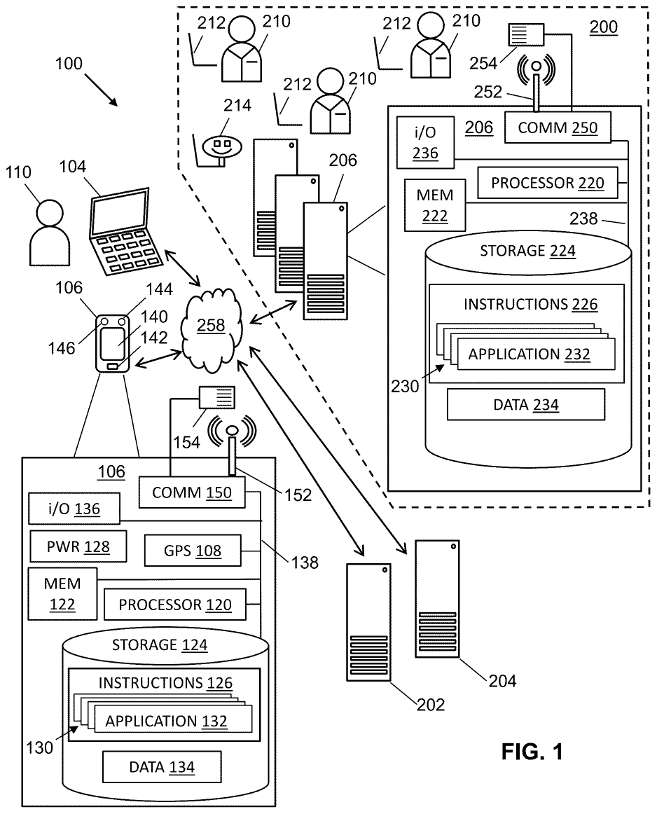

FIG. 1 illustrates a system 100 and environment thereof, according to at least one embodiment, by which a user 110 benefits through use of services and products of, or those provided at least in part with use of, an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a tablet computer, a portable digital assistant (PDA), a pager, a mobile television, a gaming device, a laptop computer, a camera, a video recorder, an audio/video player, radio, a GPS equipped device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, at table computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which include computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly-by way of intermediate component(s)-with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, tablets, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met. The agent devices 212 in some implementations serve as video conference systems for audio/video conference meetings conducted between user entities 110 agents 210. In some circumstances agent devices 212 and user devices (referring to either or both of the computing device 104 and the mobile device 106) by which a video conference is conducted are remote from each other and signals thereof are transmitted and received across the network 258.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link including WiFi. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third and fourth party systems such as merchant systems configured to interact with the user device 106 during transactions and also configured to interact with the enterprise system 200 in back-end transactions clearing processes.

In certain embodiments, one or more of the systems and devices, such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

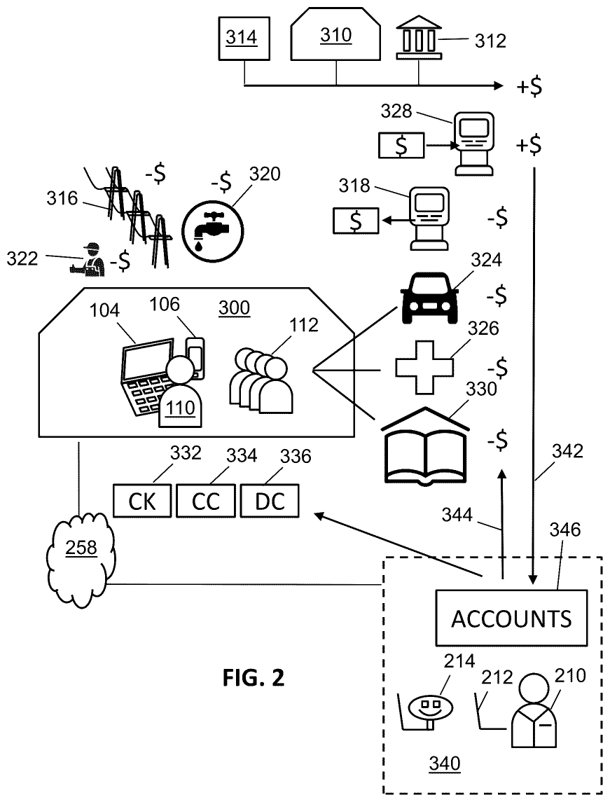

FIG. 2 represents an implementation of systems and methods for at least in part transacting user entity resources. In the illustrated example, a user entity 110 can be, in non-limiting examples, a consumer, homeowner, an employee, and a group, for example that of a household or other association. The user entity 110 is illustrated as having, as managing, as being a part of, or as otherwise an interested party with regard to a household 300. The household 300 can receive any number or type of services and products. Use of “service(s)” or “product(s)” thus relates to either or both in these descriptions. With regard, for example, to online information and services, “service” and “product” are sometimes termed interchangeably.

The interests, assets, obligations, profits, and liabilities of the household 300 are those of, or are managed at least in part by, the user entity 110. Accordingly, the household 300 and user entity 110 may be termed interchangeably herein. The household 300 and/or user entity 110 has income shown generally throughout FIG. 2 with corresponding indicia (+$), for example according to pay or other renumeration from an employer or business 310, a governmental entity 312, and other income source(s) 314 represented singly for brevity. These descriptions are not limited to any mode by which the household 300 and/or user entity 110 collects income and meets costs.

The household 300 and/or user entity 110 operates with multiple costs, shown generally throughout FIG. 2 with corresponding indicia (−$). FIG. 2 expressly illustrates representative non-limiting costs (−$), utilities like power 316 and water 320, maintenance and repairs 322, transportation costs 324 expenditures for dependents or other household members 112, including individual travel costs, health insurance premiums and other medical-related expenditures 326, and costs for training or education 330.

Each of these expenditures (−$) can be paid via, for example, checks 332 drafted by the user entity, whether checks be in paper form or electronic. The expenditures can be paid by use of credit cards 334, and debit cards 336, and other payment types. These and other transactions can be conducted, for example, online using user devices, represented as a computing device 104 and a mobile device 106 in FIGS. 1 and 2.

For a household 300 and/or user entity 110, a net increase of at least available funds is understood according to the sum of fetched increments (+$) less the sum of decrements (−$) discharged. Use of kiosks, registers, ATMs and other POS devices and cash dispensing devices and systems, together referenced as a dispenser 318, also affect account balances as decrements (−$) when making purchases and withdrawals. Conversely, use of kiosks, registers, ATMs and other POS devices and currency receiving devices and systems, together referenced as a device 328, affect account balances as increments (−$).

According to systems and methods described herein, in at least some embodiments, an entity, referenced as a service entity 340 in FIG. 2, provides a service to the user entity 110 and/or household 300 by use of the enterprise system 200 (FIG. 1) and network 258. For example, by use of the computing system 206, the service entity 340 provides systems and methods for transacting user entity resources.

The service entity 340 can be described as an enterprise entity, a business entity, a retailer, a merchant entity, a financial institution, a bank, or other service and/or product provider. The service entity 340 can access client data held, acquired, and/or stored for example as described above with reference to the storage device 224 of FIG. 1 and data 234 stored therein. The service entity 340, in some examples, can also utilize available other party data that can be purchased and/or otherwise acquired, for example as described above with reference to the external systems 202 and 204 of FIG. 1.

In the non-limiting example of FIG. 2, timestamped events representing, for example, deposits 342 into and withdrawals or payments 344 made out of accounts 346 of the user entity 110 and/or household 300 are recorded. The expenditures (−$) can be described as quantized output events for which corresponding respective output quantities are decremented from one or more quantized resource of the specific user entity 110, represented by user accounts 346, to satisfy cash withdrawals and cost-related payments, referring to the satisfaction of outgoing checks, incoming debit card charges, credit card charges, and other payments made by or on behalf of the user entity 110 in covering costs.

The revenues (+$) can be described as quantized input events for which corresponding respective input quantities are fetched from sources for deposit into one or more user account(s) 346. Fetching refers to receiving and crediting cash deposits, and to the satisfaction of deposited or incoming checks from other parties, debit card charges, credit card charges, and other payments made to or exacted by the user entity 110 in receiving payments for products and/or services as non-limiting examples. Thus, a user-entity specific quantized resource, represented by the user account(s) 446, is incremented by the respective input quantity with each input event. For example, revenue (+$) from work or other transactions deposited to the one or more user account 346 represent respective quantized input events for which records are stored with regard to the accounts to which corresponding input quantities are received or fetched.

For each deposit and payment, a corresponding signal is received by some component of the enterprise system 200 indicating a respective incoming quantized input event (deposit, +$) or outgoing quantized output event (payment, −$). The signals are conveyed between user entities, for example between the user entity 110 and the service entity 340, in a bidirectional data stream, via, for example, a network connection 258. From the perspective of the system(s) 200 and/or 206, the increments and decrements made into and out of the user accounts 346 as deposits and withdrawals respectively are driven or prompted by respective incoming received signals.

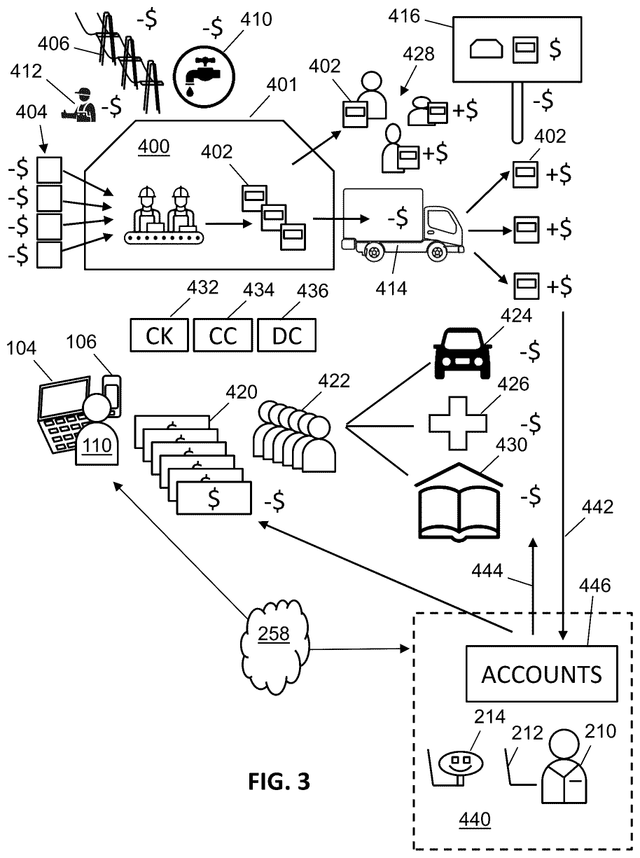

FIG. 3 represents an implementation of systems and methods for at least in part transacting user entity resources. In the illustrated example, a user entity 110 can be a proprietor, employee, manager, managing group, a corporation, or other interested party with regard to a business 400. The business 400 can offer any number or type of services and products. In some examples, the business 400 offers products 402 as graphically represented in FIG. 3. In other examples, the business offers services. Use of “service(s)” or “product(s)” thus relates to either or both in these descriptions.

The interests, assets, obligations, profits, and liabilities of the business 400 are those of, or are managed at least in part by, the user entity 110. Accordingly, the business 400 and user entity 110 may be termed interchangeably herein. The business 400 may have a “brick and mortar” facility 401 as illustrated in FIG. 3, denoting a business that operates one or more physical facilities where, for example, product fabrication and POS transactions (sales) with customers are conducted or services rendered. Additionally, or alternatively, all variations of which are within the scope of these descriptions, the business 400 may conduct business online, electronically, and/or virtually, in whole or in part. For example, the business may conduct order fulfillment without physically stocking and handling products and services, instead purchasing inventory as needed from another party or parties, such as a wholesaler or manufacture, to fulfill orders by shipment directly or indirectly to customers by drop shipping. In some embodiments within the scope of these descriptions, the business 400 provides services with or without exchange of physicals goods. In non-limiting examples, the business provides online services, walk-in services, downloads, streaming content, advisory services, and internet hosting and other activities. These descriptions are not limited to any mode by which the business 400 and/or user entity 110 collects income and meets costs.

The business 400 has income, for example according to sales of the product 402 and/or other products and services not necessarily graphically represented, shown generally throughout FIG. 3 with corresponding indicia (+$). Customers 428 having purchased product 402 as graphically represented in FIG. 3 can be walk-up customers making POS purchases and can be online purchasers as well, as non-limiting examples.

The business 400 operates with multiple costs, shown generally throughout FIG. 3 with corresponding indicia (-$). FIG. 3 illustrates, all representing respective costs (−$), incoming material supplies 404, utilities like power 406 and water 410, maintenance and repairs 412, transportation costs 414 with respect to product deliveries and/or transportation, advertising 416, payroll 420 for employees 422, travel reimbursements 424, health insurance premiums and other medical-related expenditures 426, and costs for training or education 430. These examples (−$) are representative, non-exhaustive, and non-limiting. Other costs may be incurred and satisfied for products and services not necessarily graphically represented.

Each of these expenditures (−$) can be paid via, for example, checks 432 drafted by the user entity, whether checks be in paper form or electronic. The expenditures can be paid by use of credit cards 434, and debit cards 436, and other payment types. These and other transactions can be conducted, for example, online using user devices, represented as a computing device 104 and a mobile device 106 in FIGS. 1 and 3. For a small business in one example, a net profit according to the sum of fetched increments (+$) less the sum of discharged decrements (−$) is essentially income for the proprietor.

According to systems and methods described herein, in at least some embodiments, an entity, referenced as a service entity 440 in FIG. 3, provides a service to the user entity 410 and/or business 400 by use of the enterprise system 200 (FIG. 1) and network 258. For example, by use of the computing system 206, the service entity 440 provides systems and methods for, at least in part, transacting user entity resources.

The service entity 440 can be described as an enterprise entity, a business entity, a retailer, a merchant entity, a financial institution, a bank, or other service and/or product provider. The service entity 440 can access client data held, acquired, and/or stored for example as described above with reference to the storage device 224 of FIG. 1 and data 234 stored therein. The service entity 440, in some examples, can also utilize available other party data that can be purchased and/or otherwise acquired, for example as described above with reference to the external systems 202 and 204 of FIG. 1.

In the non-limiting example of FIG. 3, timestamped events representing, for example, deposits 442 into and withdrawals or payments 444 made out of accounts 446 of the user entity 110 and/or business 400 are recorded. The expenditures (−$) can be described as quantized output events for which corresponding respective output quantities are decremented from one or more quantized resource of the specific user entity 110, represented by user accounts 446, to satisfy cost-related payments, referring to the satisfaction of outgoing checks, incoming debit card charges, credit card charges, and other payments made by or on behalf of the user entity 110 in covering costs.

The revenues (+$) can be described as quantized input events for which corresponding respective input quantities are fetched from sources for deposit into one or more user account(s) 446. Fetching refers to receiving and crediting cash deposits, and to the satisfaction of deposited or incoming checks from other parties, debit card charges, credit card charges, and other payments made to, deposited by, and/or exacted by the user entity 110 in receiving payments for products and/or services as non-limiting examples. Thus, a user-entity specific quantized resource, represented by the user account(s) 446, is incremented by the respective input quantity with each input event. For example, revenue (+$) from sales deposited to the one or more user account 446 represent respective quantized input events for which records are stored with regard to the accounts to which corresponding input quantities are deposited and/or fetched.

For each deposit and payment, a corresponding signal is received by some component of the enterprise system 200 indicating a respective incoming quantized input event (deposit, +$) or outgoing quantized output event (payment, −$). The signals are conveyed between user entities, for example between the user entity 110 and the service entity 440, in a bidirectional data stream, via, for example, a network connection 258. From the perspective of the system(s) 200 and/or 206, the increments and decrements made into and out of the user accounts 446 as deposits and withdrawals respectively are driven or prompted by respective incoming received signals.

The above-described benefits and advantages are provided in various embodiments of the enterprise system 200 of FIG. 1, which can be described in view of FIGS. 2-3 as conveying, receiving, sending, and monitoring quantized signals in a bidirectional data stream, and storing records thereof. The system 200 includes a computing system 206 having one or more processor 220 and at least one of a memory device 222 and a non-transitory storage device 224. The one or more processor executes computer-readable instructions 226, and a network connection 258 operatively connecting user devices 104 and 106 to the computing system. Upon execution of the computer-readable instructions, the computing system performs steps for each specific user entity 110 of multiple user entities.

The steps, in various embodiments of the system 200, include: receiving input event signals and storing corresponding input event records associated with the specific user entity, each of the input event records representing a respective quantized input event; and incrementing, for at least some of the input event records, one or more quantized resource of the specific user entity by a respective input quantity. In FIGS. 2-3, the revenues (+$) represent quantized input events for which corresponding input quantities are deposited and/or fetched from sources for deposit into one or more user account (346, 446) and for which records are stored with regard to the accounts to which the input quantities are fetched.

The steps can further include: receiving output event signals and storing corresponding output event records associated with the specific user entity, each of the output event records representing a respective quantized output event; and decrementing, for at least some of the output event records, a respective output quantity from the one or more resource of the specific user entity. In FIGS. 2-3, the expenditures (−$) represent quantized output events for which corresponding respective output quantities are discharged or decremented from one or more user account (346, 446), and for which records are stored with regard to the accounts from which corresponding output quantities are decremented.

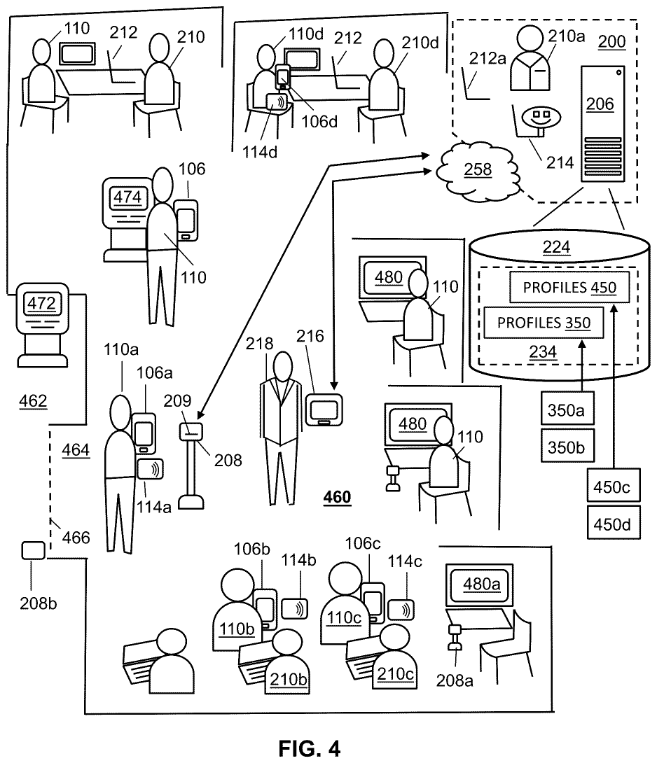

In various system and methods according to embodiments expressly described herein and those inferred therefrom, interactions between a user entity 110 and any agent (210, 214) are monitored, recorded, summarized or data mined to create and store user profiles (350, 450, FIG. 4) for use in personalizing further communications, services, and greetings in some examples upon user arrival at a branch location of the service entity (340, 440). The records for the events as described in FIGS. 2-4, and information regarding accounts, actions, and resources for each particular user entity are kept as or associated with respective user profiles (350, 450).

The service entity can thus focus on client needs and client success in implementing client centered communication and engagement strategies. Embodiments of systems and methods described herein ethically use the large data resources 234 about user entities to create or select trustworthy recommendations and interactions that deepen client relationship in a cycle built on hyper-personalization to provide services, products, and options to users. Advanced analytics can be used to leverage machine learning and AI to optimize product offerings and provisions, and to personalize and optimize client engagement and network opportunities. Personalized content that is relevant and inspiring to client specific situations and needs can be generated and provided. Cross channel delivery, referring to coordinated communications by multiple modes and/or agents, assures the right message, right channel, and right time for clients. Such coordination can entail email, text, online chat, phone conversations, and in-person greetings, for example at branch locations. Thus managed records, represented at least by profiles 350 and profiles 450, are utilized by human agents, virtual agents, and combinations thereof.

According to some embodiments, and with reference at least to FIG. 4, in a branch location environment, novel and advantageous systems, methods, and devices are utilized in coordination to drive personalized messaging and service offerings for a hyper-personalized user-entity experience. The service entity manages user profiles and uses collected information to guide agents in suggesting products and service needs, to guide sales and service activities, to generate and/or offer digital interaction, in-property interaction, and sales interaction.

Interactions that are recorded in whole or in part for personalization of upcoming interactions include online sessions, email, automated or semi-automated sent physical mail, and in-property interactions, which can include visits to ATMs and branch locations, sales interactions, and call center interactions, as non-limiting and non-exhaustive examples. These interactions are subject to data integration and processes to or by which analytics applied for pertinent information dissemination to agents is conducted.

The data integration may trigger events such as real time personalized offers of service and assistance during a branch visit by providing insightful information to branch-location agents guiding interactions with both human agents and automated digital interactions. Advisory messaging can be directed to users via human agents and/or virtual agents.

In FIG. 4 diagrammatically facility 460 represents a branch office and/or point-of-sale (POS) location of a service entity, for example as described above with reference to the service entity 340 and/or the service entity 440, which can be the same service entity. The computing system 206 maintains and stores profiles respectively associated with user entities. User profiles 350 (FIG. 4) represent those of non-business user entities 110 within the scope of the descriptions of FIG. 2. User profiles 450 represent those of business user entities 110 within the scope of the descriptions of FIG. 3.

The facility 460 is illustrated as having an exterior automatic teller machine 472, for example at an exterior walk-up or drive-up location, and an interior ATM 474. Multiple agents 210b, and 210c are available to provide services to user entities. In the illustrated example, the agents 210b, 210c represent banking tellers in at least one example within the scope of FIG. 4. One or more special service agent 210d is available, for example each in a private space such as a meeting room or sub-office, representing banker and/or advisors for advanced services. In some examples, agent 210a is remote from the facility 460 and may interact with user entities via video conference systems 480 within the facility 460, each of which can also be in a private space such as a meeting room or sub-office within the facility. Lock deposit boxes for securing user-entity items may be within the facility 460, for example in a secure and private area. These provisions shown at least once expressly in FIG. 4 and/or described represent their kind in any number.

Multiple users (110a, 110b, 110c, 110d) are illustrated in FIG. 4, representing examples each according to descriptions above with reference to the user entity 110. The user 110a utilizes one or more user device 106a, referring to either or both of the computing device 104 and the mobile device 106 (FIG. 1) unless otherwise specified. Other respective user devices (106b, 106c, 106d) are shown among the other users (110b, 110c, 110d) in FIG. 4, for which the device 106 serves for brevity as a singly described example with reference to FIG. 1. The user 110a utilizes one or more registration device 114a by which arrival of the user 110a in possession of the registration device 114a is sensed by a proximity sensing terminal 208 in communication with the computing system 206, for example via network 258, enabling the computing system to send communications and control signals to devices and systems within and/or at the facility 460 responsively to the registration device engaging the proximity sensing terminal 208. Where the network 258 is referenced in descriptions of FIG. 4, any local wireless links such as facility Wi-Fi and/or any facility specific communications equipment and/or hard wire connections are included, as well as internet connections to systems and devices local to and remote from the facility 460.

The registration device 114a in non-limiting and non-exhaustive examples, can be a card device and/or fob device including an embedded integrated circuit chip and an antenna, and a mobile device including a processor, a memory device, a non-transitory storage device, and an antenna for example within the scope of the descriptions of user device 106. Other respective registration devices (114b, 114c, 114d) are shown among the other users (110b, 110c, 110d). For brevity, the descriptions herein of the registration device 114a apply as well to the registration devices (114b, 114c, 114d). Where use of the registration device 114a is described herein, that use may be provided by the user device 106a in lieu of or in combination with the registration device 114a.

The registration device 114a may accordingly be characterized as a field-enabled card and/or a frequency-operated button (fob), a key fob, a credit card, a debit card, a smart card, a smartphone and/or another mobile device using radio-frequency identification (RFID) or near-field communication (NFC). The registration device 114a in some examples applies tokenization in which user and/or issuer details are encapsulated within data accessible to and/or accessed by a software application or other processor executed code. In some embodiments, the registration device 114a and the user device 106a are the same device and/or the registration device 114a is onboard the user device 106a, such that reference to either one refers as well to the other, both of which are field-enabled devices.

The proximity sensing terminal 208, in non-limiting and non-exhaustive examples, can be characterized as at least one of a radio-frequency identification (RFID) reader and a near-field communication (NFC) reader. Thus, the terminal 208 can be used for contact free or tap contact engagement and registration of various devices such field-enabled cards, fobs, credit cards, debit cards, smart cards, and other devices, including smartphones and other mobile devices using radio-frequency identification (RFID) or near-field communication (NFC). The user entity 110a engages the registration device 114a with the terminal 208 for interaction therebetween by physical proximity of the device 114a and terminal 208. These descriptions include such contact free and/or tap type engagement and insertion type engagements as well for such examples in which the registration device is inserted into a slot 209 of the proximity sensing terminal 208. For brevity, the descriptions herein of the proximity sensing terminal 208 apply as well to other proximity sensing terminals (208a, 208b) in FIG. 4, the uses of which are separately described with reference to the respective location and use of each at or within the facility 460 and its role in the system 200.

As the user entity 110a engages the proximity sensing terminal 208 with the registration device 114a by proximity, contact, or insertion, the terminal 208 retrieves and/or receives identifying data to identify the registration device 114a and/or stored user profiles 350a unique to the particular user entity 110a. The proximity sensing terminal 208 sends an embedded-data signal to the computing system 206 upon sensing the registration device 110a, the signal conveying identifying data by which a profile to which the particular registration device is associated can be identified. The computing system uses the identifying data to identify and access the particular stored user entity-profile 350a associated with the identifying data and user entity 110a. The stored user entity profile 350a contains user entity specific data as described above with reference at least to FIGS. 2-3 and profiles 350 and 450. The computing sends data including a portion of the user-specific data to the primary agent device 216, and the primary agent device 216 displays content 217 at least representative of the portion of the user-specific data. This enables the primary agent to greet and assist the user entity 110a in a customized way.

The portion of the user-specific data sent to the primary agent device 216 can include an access event record indicating any failure or fulfillment of any transaction, application, service or product in use by and/or of interest to the particular user entity, thereby alerting the primary agent 218 by way at least of the content 217 displayed as to what assistance should be provided a user entity. The content 217 is displayed automatically in some embodiments upon receipt by the primary agent device 216 of the data including the portion of the user-specific data sent by the computing device 206.

With or without express illustration, for each user entity (110c, 110d) a particular user profile is included in the user profiles 350. Similarly, without or without express illustration of a corresponding user entity, each user entity profile (450a, 450b), corresponds to a particular user entity.

According to the function and role of each proximity sensing terminal (208, 208a, 208b, 208c, 208d) the computer system receives identifying data upon a registration device engaging the terminal, the computing system identifies the authorities, access rights and/or privileges granted to the particular use entity 110a as indicated in the stored user profile 350a. The computing system is enabled, for example by use of network 258 and/or any facility specific communications equipment and/or hard wire connections, to signal, activate, and/or control various devices and systems associated with the proximity sensing terminal, according to the role of the proximity sensing terminal.

The respective user profiles 350a and 350b of the user entities 110a and 110b may have different levels of authorities, access, and/or privileges, such that the reception, service, and or access granted to the user entities may vary.

The various devices and systems the computing system 206 is enabled to signal, activate, and/or control include multiple types of secure devices, including physical access controllers such as electrically and/or electronically locking doors, such as the lobby door 466 controlling access from the exterior 462 of the facility 460 to the interior thereof. A dedicated proximity sensing terminal 208b at the lobby door is illustrated for enabling the computer system to activate the door upon sensing a registration device at the terminal 208b for user entities allowed access according to their profiles.

Advantageously, the system 200 includes a primary agent device 216, for example carried by a primary agent 218. While additional features and benefits of the primary agent device 216 are described herein, the primary agent device 216 serves the primary agent 218 at least in some capacity as the agent devices 212 serve the agents 210. Thus descriptions herein of the agent devices 212 apply to the primary agent device 216 as well. In at least one embodiment well suited for implementation of devices, methods and systems described particularly herein, the primary agent device 216 is a mobile tablet computer with processing and communication capabilities. Other exemplary devices characterized as smart phones and other portable computing devices can serve as well as the primary agent device 216.

The primary agent device 216 present in the facility 460 enables very personalized receptions, greetings, services and guidance to user entities by empowering the primary agent 218 with the knowledge database represented at least in part by the stored profiles (350, 450) and other information and content available as the primary agent travels within the facility to interact with user entities.

The primary agent device 216 is in at least wireless communication with the computing system 206, for example via the network 258. When the proximity sensing terminal 208 sends the embedded-data signal to the computing system 206 upon sensing the registration device 110a, and identifying data corresponds to a particular stored user entity-profile 350a, the computing system 206 sends user-specific data to the primary agent device 216 for display at least in part thereby informing the primary agent 218 of the arrival and/or presence of at least the registration device 114a and presumably the user entity 110a with whom the particularly registration device 114a is associated. The primary agent 218 is thus enabled by information to greet and assist the user entity 110a in a customized way, having user profile information at hand by way of the primary agent device 216.

In various embodiments, the primary agent device 216 plays a pivotal role within and is a component of a system for video conferencing upon a proximity condition. In such embodiments, the computing system 206, when prompted by receipt of the embedded-data signal from the proximity sensing terminal 208, identifies a stored user entity profile 350a associated with the identifying data conveyed by the signal, and accesses user entity specific data of the user entity 110a within the profile.

The computing system concatenates a data exchange by sending first data and second data to the primary agent device 216. The first data includes a portion of the user-specific data to the primary agent device 216, and the primary agent device displays content 217 at least representative of that portion of the user-specific data, thus enabling the primary agent to greet and assist the user entity 110a in a customized way. The displayed 217 content includes, in non-limiting and non-exhaustive examples, information identifying the user entity, a digital image of the user entity, account information about the user entity, services and products of the service entity (340, 440) used by or accessible to the user entity, and one or more record of communication between user entity and the service entity (340, 440) and/or any agent thereof. The displayed content 217 includes, in non-limiting and non-exhaustive examples, indications of levels of authorities, access, and/or privileges permitted the user entity by the service entity (340, 440). The reception, service, and or access granted to the user entities may accordingly vary by actions of the primary agent 216.

The second data includes an indication of optional content, and the primary agent device 216 displays content at least representative of the optional content. The optional content may be offered to the user entity 110a via an offer sent to the registration device 114a, the user device 106a, and/or the primary agent device 216, for consideration by the user entity, for example when engaged in conversation or electronic communication with the primary agent 218. A reply to the offer may be sent by the receiving device or another, and in further reply the computing system may send a segment of the optional content to the registration device 114a, the user device 106a, and/or the primary agent device 216 for further use and/or consideration by the user entity 110.

Once interaction has begun by engagement of the proximity sensing terminal 208a by the registration device 114a or user device 106a serving as the registration device, interaction may continue in various embodiments via another user computing device associated with the identifying data by which the stored user entity-profile 350a of the user entity 110a is identified. For example, video conferencing may be scheduled during an interaction at the facility 460, and then later conducted when the user entity 110a is at another location such as the facility 401 or the household 300 and by use a user device 104.

The optional content in some embodiments relates to video conferencing services available to the user entity 110 at the facility 460. For example, the primary agent 218 by use of the content displayed by the primary agent device 216 can offer customized advisory assistance for advanced services by a special agent, and in some case no special agent is tentatively available, for example the special service agent 210d may be currently engage with another user entity 110d. In another example, a highly-qualified agent 210a specializing in a services or products of interest to the user entity may be remote from the facility. In such circumstances, a remote video conferencing session can be offered to the user entity 110a by use of the video conference system 480a (FIG. 4).

In some embodiments, the computing system, for example automatically or by prompt by the primary agent device 216, sends at least a first portion of the optional content to the first or on-site video conference system 480a for display, and sends at least a second portion of the optional content to the agent device 212a, which serves as an off-site secure-area video conference system. The computing system 206 further conducts a video conference between the first video conference system 480a and the second video conference system 212a via the network connection 258.

Multiple video conferences are represented in FIG. 4 as concurrently conducted by the computing system 206 via multiple video conference systems 480. Walk-in customers with and without appointments are invited to enjoy and benefit from such video conferences, each user entity 110 being engaged by content related to services and products within their respective interests.

The video conference offered to the user entity 110a relating to a service or product of interest to the user entity is at least in part coordinated via the first portion of the optional content sent to the first video conference system 480a, such as customer oriented information about services provided by the service entity (340, 440), and the second portion of the optional content sent to the second video conference system 112a, such as agent-oriented information including business-side information about the services being offered to the user entity 110a.

Sending the first portion of the optional content to the first video conference system 480a may automatically trigger the first video conference system to display the received content and initiate the video conference, or the display and video may be prompted by the primary agent device 216 receiving input from the primary agent 218 and sending the computing system a prompt thus confirming interest and participation by user entity 110a.

Receiving the prompt, via the network connection from the primary agent device 216, in some embodiments automatically triggers the computing system 206 to select the first video conference system 480a from multiple video conference systems 480 in the common facility 460. For example, other video conference systems 480 may be busy at the time conducting video conferences or providing tutorials to other user entities 110.

The prompt may further automatically trigger the computing system to send an indication of the location of the first video conference system 480a within the common facility 460 to at least one of the primary agent device 216, the registration device 114a, and the user device 106a. The user entity 110a is thus guided to the first video conference system 480a by display of the location or instructions for travel thereto.

The prompt may further automatically trigger the computing system 206 to select the second video conference system 212a from multiple video conference systems, represented by agent devices 212 both local to and remote from the facility 460.

Receiving the prompt, via the network connection 258 from the primary agent device 216, in some embodiments automatically triggers the computing system 206 to schedule a time for the first video conference system to display the first portion of the optional content, and send an indication of the scheduled time to at least one of the primary agent device 216, the registration device 114a, and the user device 106a.

In some embodiments, the video conference system includes a second proximity sensing terminal 208a sending an arrival signal to the computing system upon sensing the registration device 114a arriving at the first video conference system 480a, for example by engagement of the registration device 114a by the user entity 110a with the second proximity sensing terminal 208a. Upon receipt of the arrival signal, the computing system 206 and or first video conference system 480a may automatically trigger the display the first portion of the optional content, such as customer-oriented information as described above.

The above-described features of the computing system 206 and other components of the system 200, when operatively performing as described above, together define various embodiments of systems for video conferencing upon a proximity condition and corresponding methods therefor as well.

These such systems and methods are distinguished over what can be feasibly accomplished by, for examples, manual action by system administrators assisting agents and users due at least to the unpredictability of user arrivals and what content they may request and/or accept. Any given user may arrive at any given facility and provided a customized reception enabled by the primary agent device utilizing user profile data retrieved in real time as the user entity arrival is established by use of proximity sensing devices. Multiple video conferences can be concurrently conducted by the computing system 206 via multiple video conference systems 480 for walk-in customers with and without appointments and be engaged by content related to services and products within their respective interests, for example according to information in their respective profiles. Only modern processors can feasibly coordinate the possible peak data flow of the above-described activities when dozens and even hundreds of video conferences, and thousands of user arrivals at respective facilities, are occurring concurrently.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A video conference system comprising:
a computing system comprising at least one processor and at least one of a memory device and a non-transitory storage device, wherein said at least processor executes computer-readable instructions;
a network connection for operatively connecting devices to the computing system;
a first proximity sensing terminal sending an embedded-data signal to the computing system upon sensing a registration device, the signal conveying identifying data;
a primary agent device in wireless communication with the computing system via the network connection;
a first video conference system in communication with the computing system via the network connection; and
a second video conference system in communication with the first video conference system via the network connection,
wherein, upon execution of the computer-readable instructions, the computing system performs steps comprising:
receiving the embedded-data signal;
identifying a stored user entity-profile associated with the identifying data, the stored user entity profile containing user entity specific data;
concatenating data exchanges by at least:
sending first data comprising a portion of the user-specific data to the primary agent device, wherein the primary agent device displays content at least representative of the portion of the user-specific data; and
sending second data comprising an indication of optional content to the primary agent device, wherein the primary agent device displays content at least representative of the optional content;
sending at least a first portion of the optional content to the first video conference system, wherein the first video conference system displays the first portion of the optional content;
sending at least a second portion of the optional content to the second video conference system, wherein the second video conference system displays the second portion of the optional content; and
conducting a video conference between the first video conference system and the second video conference system via the network connection.

2. The video conference system of claim 1, wherein sending the first portion of the optional content to the first video conference system comprises sending at least the first portion of the optional content via the network connection.

3. The video conference system of claim 2, wherein sending the first portion of the optional content to the first video conference system automatically triggers the first video conference system to display at least video content of the first portion of the optional content.

4. The video conference system of claim 3, the steps performed by the computing system further comprise, before sending the first portion of the optional content to the first video conference system, receiving a prompt, via the network connection from the primary agent device, to send at least the first portion of the optional content to the first video conference system.

5. The video conference system of claim 4, wherein receiving the prompt, via the network connection from the primary agent device, automatically triggers the computing system to send at least the first portion of the optional content to the first video conference system.

6. The video conference system of claim 5, wherein receiving the prompt, via the network connection from the primary agent device, automatically triggers the computing system to select the first video conference system from multiple video conference systems in a common facility.

7. The video conference system of claim 6, wherein receiving the prompt, via the network connection from the primary agent device, automatically triggers the computing system to send an indication of the location of the first video conference system within the common facility to at least one of the primary agent device and the registration device.

8. The video conference system of claim 6, wherein the proximity sensing terminal and the primary agent device are within the common facility.

9. The video conference system of claim 8, wherein the second video conference system is remote from the common facility.

10. The video conference system of claim 5, wherein receiving the prompt, via the network connection from the primary agent device, automatically triggers the computing system to select the second video conference system from multiple video conference systems remote from the common facility.

11. The video conference system of claim 5, wherein receiving the prompt, via the network connection from the primary agent device, automatically triggers the computing system to schedule a time for the first video conference system to display the first portion of the optional content, and send an indication of the scheduled time to at least one of the primary agent device and the registration device.

12. The video conference system of claim 2, further comprising a second proximity sensing terminal sending an arrival signal to the computing system upon sensing the registration device arriving at the first video conference system.

13. The video conference system of claim 12, wherein the computing system automatically triggers the first video conference system to display at least the first portion of the optional content upon receiving the arrival signal.

14. The video conference system of claim 1, wherein the steps performed by the computing system further comprise sending an offer of the optional content to the registration device.

15. The video conference system of claim 14, further comprising, upon receiving a reply to the offer from the registration device, sending at least a segment of the optional content to the registration device over the network connection.

16. The video conference system of claim 1, wherein:
the first proximity sensing terminal comprises at least one of a radio-frequency identification (RFID) reader and a near-field communication (NFC) device;
the primary agent device comprises a mobile device including a processor, a memory device, a non-transitory storage device, a display, and an antenna; and
the registration device comprises at least one:
a mobile device including a processor, a memory device, a non-transitory storage device, and an antenna; and
a card including an embedded integrated circuit chip and an antenna; and
a fob including an embedded integrated circuit chip and an antenna.

17. The video conference system of claim 1 wherein conducting the video conference between the first video conference system and the second video conference system via the network connection comprises sending live audio and video content from the first video conference system to the second video conference system, and sending live audio and video content from the second video conference system to the first video conference system.

18. The system of claim 1, wherein, upon execution of the computer-readable instructions, the computing system performs steps comprising, for each specific user entity of multiple user entities:
receiving input event signals and storing corresponding timestamped input event records in a user entity-profile associated with the specific user entity, each of the timestamped input event records representing a respective quantized input event;
incrementing, for at least some of the timestamped input event records, one or more quantized resource of the specific user entity by a respective input quantity;
receiving output event signals and storing corresponding timestamped output event records in a user entity-profile associated with the specific user entity, each of the timestamped output event records representing a respective quantized output event; and
decrementing, for at least some of the timestamped output event records, a respective output quantity from the one or more quantized resource of the specific user entity.

19. A method for a computing system to conducting a video conference system across a network connection, the computing system comprising at least one processor and at least one of a memory device and a non-transitory storage device, the network connection operatively connecting devices to the computing system, wherein, upon execution of the computer-readable instructions, the computing system performs steps comprising:
receiving an embedded-data signal from a first proximity sensing terminal, the signal conveying identifying data;
identifying a stored user entity-profile associated with the identifying data, the stored user entity profile containing user entity specific data;
concatenating data exchanges by at least:
sending first data comprising a portion of the user-specific data to a primary agent device, wherein the primary agent device displays content at least representative of the portion of the user-specific data; and
sending second data comprising an indication of optional content to the primary agent device, wherein the primary agent device displays content at least representative of the optional content;
sending at least a first portion of the optional content to a first video conference system, wherein the first video conference system displays the first portion of the optional content;
sending at least a second portion of the optional content to a second video conference system, wherein the second video conference system displays the second portion of the optional content; and
conducting a video conference between the first video conference system and the second video conference system via the network connection.

20. A video conference system comprising:
a computing system comprising at least one processor and at least one of a memory device and a non-transitory storage device, wherein said at least processor executes computer-readable instructions;
a network connection for operatively connecting devices to the computing system;
a proximity sensing terminal sending an embedded-data signal to the computing system upon sensing a registration device, the signal conveying identifying data;
a primary agent device in wireless communication with the computing system via the network connection; and
a first video conference system in communication with the computing system via the network connection,
wherein, upon execution of the computer-readable instructions, the computing system performs steps comprising:
receiving the embedded-data signal; and
identifying a stored user entity-profile associated with the identifying data, the stored user entity profile containing user entity specific data;
concatenating data exchanges by at least:
sending first data comprising a portion of the user-specific data to the primary agent device, wherein the primary agent device displays content at least representative of the portion of the user-specific data; and
sending second data comprising an indication of optional content to the primary agent device, wherein the primary agent device displays content at least representative of the optional content;
sending at least a first portion of the optional content to the first video conference system, wherein the first video conference system displays the first portion of the optional content; and
sending at least a second portion of the optional content to at least one of the registration device and a computing device indicated in the stored user entity-profile associated with the identifying data.
